(19) United States
(12) Patent Application Publication
(10) Pub. No.: US 2009/0242145 A1
(43) Pub. Date: Oct. 1, 2009

(54) MOTORIZED SHADE ASSEMBLY WITH REDUCED VIBRATION AND NOISE

(76) Inventor: Jia Yih SHEU, (US)

Correspondence Address: Dr. BANGER SHIA;Int''l Patent Office of Bang Shia, 102 Lindencrest Ct, Sugar Land, TX, 77479-5201, US

(21) Appl. No.: 12/058,738

(22) Filed: Mar. 30, 2008

(51) Int. Cl. E06B 9/56

(52) U.S. Cl. 160/311

(57) ABSTRACT

A motorized shade assembly includes a housing having a compartment defined by an inner periphery. A driving device is mounted in the compartment and includes a shaft. An operating rod is coupled with the shaft to turn therewith. A shade is coupled to the operative rod to move therewith. A vibration absorbing member is made of a buffering, flexible material and includes a central hole having an inner periphery clamping the driving device. The vibration absorbing member further includes an outer periphery pressing against the inner periphery of the housing. The driving device is operable to move the operating rod and the shade. The vibration absorbing member reduces vibration and noise generated during operation of the driving device.

### BACKGROUND OF THE INVENTION

1. Field of the Invention

The present invention relates to a motorized shade assembly and, more particularly, to a motorized shade assembly having a shade that can be lifted or lowered with reduced vibration and noise.

2. Description of the Related Art

Conventional blinds, window shades, projection screens, etc. are motorized to provide convenient lifting or lowering operation. FIG. 6 shows a conventional motor device including a motor 1′, a speed reducer 2′ coupled to the motor 1′, and an operating rod 3′ around which a shade or the like is coupled. Operating rod 3′ is coupled to and drivable by a shaft 21′ of speed reducer 2′ to lift or lower the shade. Motor 1′, speed reducer 2′ and operating rod 3′ are mounted in a housing 4′ in which an L-shaped plate 5′ is mounted. A portion of L-shaped plate 5′ includes fixing holes 51′ through which fasteners extend into holes 22′ of speed reducer 2′. L-shaped plate 5′ further includes a through-hole 53′ through which shaft 21′ extends. Thus, motor 1′ and speed reducer 2′ can be fixedly mounted to the housing 4′.

However, vibration generated during operation of motor 1′ and speed reducer 2′ is directly transmitted to L-shaped plate 5′ and housing 4′, leading to high noise. Furthermore, in a case that operating rod 3′ shifts away from a longitudinal axis X of the housing 4′, the reactive force imparted to motor 1′ and speed reducer 2′ causes shifting of motor 1′ and speed reducer 2′, leading to an increase in the load to motor 1′ and speed reducer 2′ as well as high noise and non-smooth operation.

### BRIEF SUMMARY OF THE INVENTION

An objective of the present invention is to provide a motorized shade assembly having a shade that can be lifted or lowered with reduced vibration and noise.

A motorized shade assembly according to the preferred teachings of the present invention includes a housing having a compartment defined by an inner periphery. A driving device is mounted in the compartment and, in a most preferred form, includes a motor and a speed reducer drivable by the motor and having a shaft. An operating rod is coupled with the shaft to turn therewith. A shade is coupled to the operative rod to move therewith. A vibration absorbing member is made of a buffering, flexible material and includes a central hole having an inner periphery clamping the driving device. The vibration absorbing member further includes an outer periphery pressing against the inner periphery of the housing. The driving device is operable to move the operating rod and the shade. The vibration absorbing member reduces vibration and noise generated during operation of the driving device.

In the most preferred embodiment, the motorized shade assembly further includes an outer sleeve mounted in the compartment of the housing. A transmission block is mounted in the outer sleeve and including a first end coupled with the shaft and a second end. A first protrusion is formed on the second end of the transmission block. A guide mounted is in the outer sleeve and includes first and second grooves formed in first and second ends thereof. The second groove extends perpendicularly to the first groove. The first groove is larger than and receives the first protrusion of the transmission block such that the guide is capable of moving jointly with the transmission block and capable of shifting relative to the transmission block. A coupling block is mounted in the outer sleeve and includes a second protrusion formed on a first end thereof. The second protrusion of the coupling block is smaller than and received in the second groove such that the coupling block is capable of moving jointly with the guide and capable of shifting relative to the guide, with the coupling block further including a second end coupled with the operative rod.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a partial, exploded, perspective view of a motorized shade assembly according to the preferred teachings of the present invention.

FIG. 2 shows a partial, perspective view of the motorized shade assembly of FIG. 1 with a housing and a shade of the motorized shade assembly shown in phantom lines.

FIG. 3 shows a partial, cross-sectional view of the motorized shade assembly of FIG. 1.

FIG. 4 shows another cross-sectional view of the motorized shade assembly of FIG. 1.

FIG. 5 shows a modified example of the motorized shade assembly of FIG. 1.

FIG. 6 shows a conventional motor device for a shade.

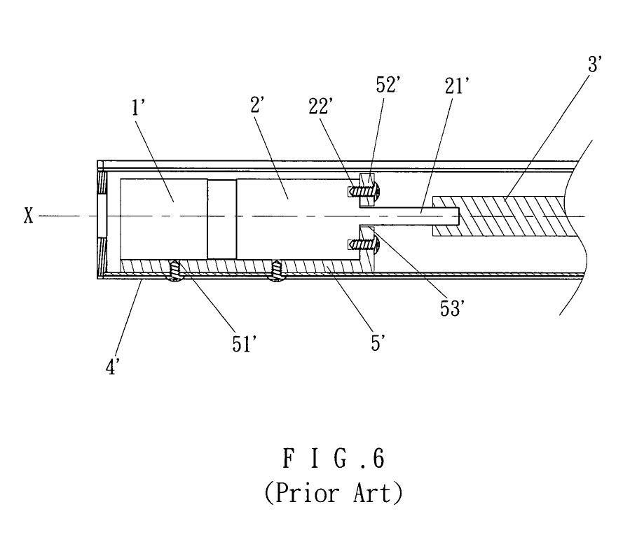

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

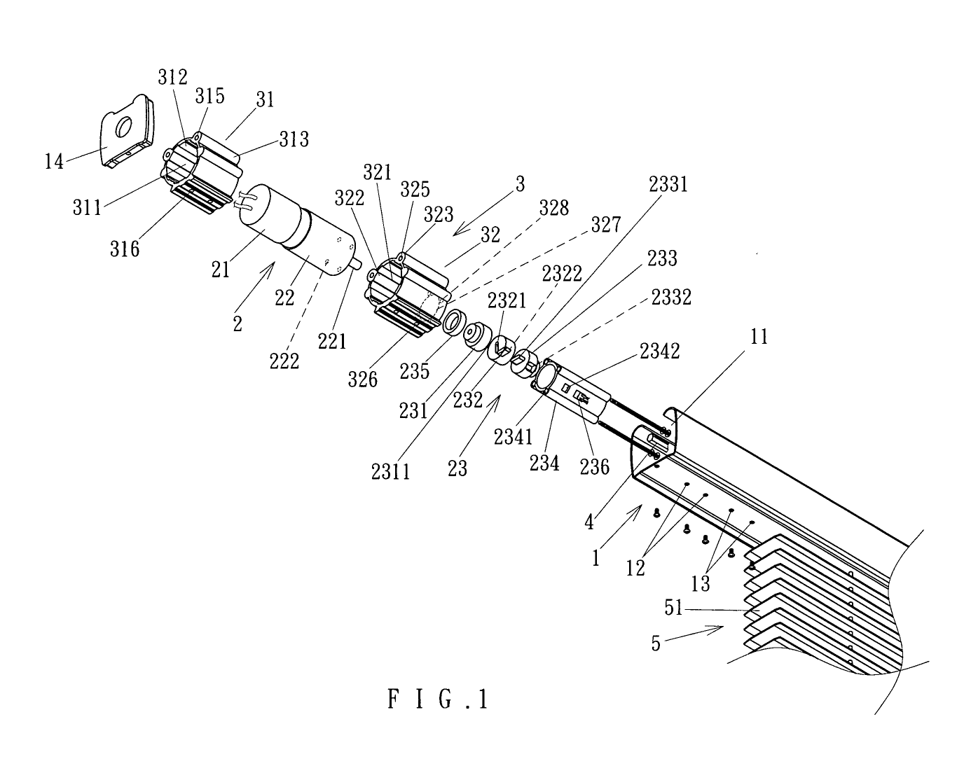

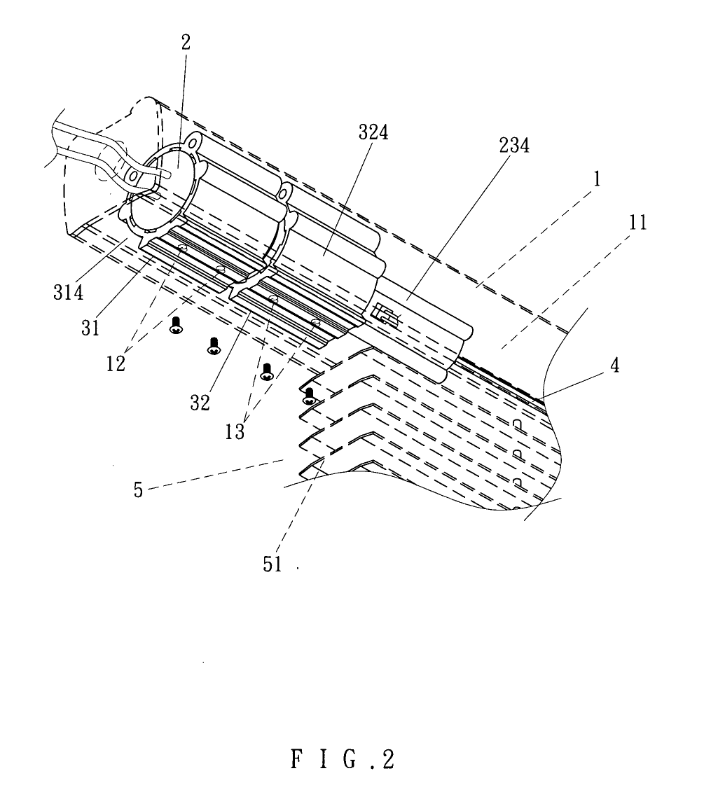

A motorized shade assembly of an example according to the preferred teachings of the present invention is shown in FIGS. 1-4 of the drawings and includes a housing 1, a driving device 2, a vibration absorbing member 3, an operating rod 4, and a shade mechanism 5. Housing 1 includes a compartment 11 having an end opening covered by an end cap 14. Housing 1 further includes a plurality of fixing holes 12 and 13.

Driving device 2 is mounted in compartment 11 and includes a motor 21 and a speed reducer 22 having a shaft 221 drivable by motor 2. Speed reducer 22 includes a plurality of fixing holes 222. A transmission mechanism 23 is coupled to shaft 221 and includes a transmission block 231, a guide 232, a coupling block 233, and an outer sleeve 234. An end of transmission block 231 is coupled with shaft 221 to turn therewith. A protrusion 2311 is formed on the other end of transmission block 231. Guide 232 includes a first groove 2321 in a first end thereof and a second groove 2322 in a second end thereof opposite first groove 2321. Second groove 2322 extends perpendicularly to first groove 2321. First groove 2321 is larger than and receives protrusion 2311 such that guide 232 can move jointly with transmission block 231 and that guide 232 can shift relative to transmission block 231. Coupling block 233 includes a protrusion 2331 on an end thereof. Protrusion 2331 is smaller than and received in second groove 2322 of guide 232 such that coupling block 233 can move jointly with guide 232 and that coupling block 233 can shift relative to guide 232. Coupling block 233 further includes an engaging portion 2332 on the other end thereof. Outer sleeve 234 receives transmission block 231, guide 232, and coupling block 233. Outer sleeve 234 includes a plurality of fixing holes 2341 aligned with fixing holes 222 of speed reducer 2. A magnetic ring 235 is mounted around transmission block 231. Outer sleeve 234 includes a through-hole 2342 receiving a sensor 236 coupled with control members (not labeled). Sensor 236 detects the angular position of magnetic ring 235 and sends a signal indicative of the angular position of magnetic ring 235 to the control members to control operation of motor 21, providing positioning of shade mechanism 5.

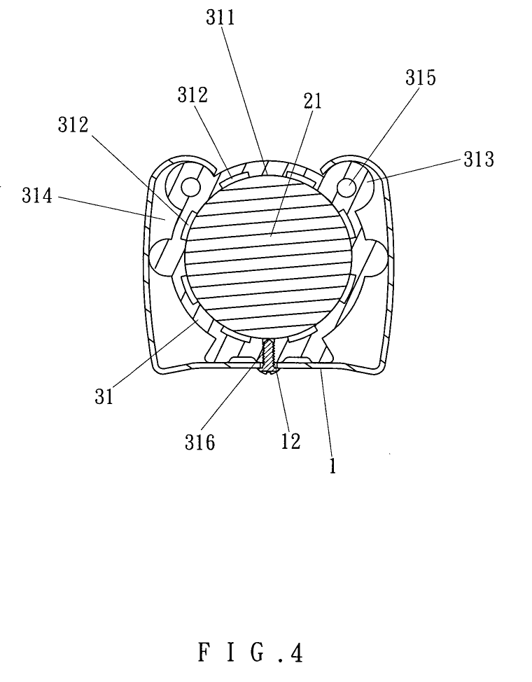

Vibration absorbing member 3 is made of a buffering, flexible material such as rubber, silicon rubber, etc. According to the preferred form shown, vibration absorbing member 3 includes front and rear sleeves 31 and 32 separately manufactured to prevent deformation due to excessive length of the vibration absorbing member 3 in the form of a single sleeve. Sleeves 31 and 32 can be mounted around motors and speed reducers of various sizes. Front sleeve 31 includes a central hole 311 having an inner periphery that clamps motor 21 with an appropriate tightness. A plurality of recesses 312 are formed on the inner periphery of central hole 311 of front sleeve 31. Recesses 312 are not in contact with motor 21. Front sleeve 31 further includes a plurality of ribs 313 formed on an outer periphery thereof. Ribs 313 press against an inner periphery of housing 1 with appropriate tightness, with gaps 314 existing between the outer periphery of rear sleeve 32 and the inner periphery of housing 1 (FIG. 4). Some of ribs 313 include a hole 315. Front sleeve 31 further includes engaging holes 316 aligned with fixing holes 12. Rear sleeve 32 includes a central hole 321 having an inner periphery that clamps speed reducer 22 with an appropriate tightness. A plurality of recesses 322 are formed on the inner periphery of central hole 321 of rear sleeve 32. Recesses 322 are not in contact with speed reducer 22. Rear sleeve 32 further includes a plurality of ribs 323 formed on an outer periphery thereof. Ribs 323 press against the inner periphery of housing 1 with appropriate tightness, with gaps 324 existing between the outer periphery of rear sleeve 32 and the inner periphery of housing 1. Some of ribs 323 include a hole 325. Rear sleeve 32 further includes engaging holes 326 aligned with fixing holes 13. Rear sleeve 32 further includes an inner flange 327 in an end thereof. Annular flange 327 includes fixing holes 328 aligned with fixing holes 222 of speed reducer 22. Fasteners are extended through fixing holes 2341 of outer sleeve 234, fixing holes 328 of rear sleeve 32 and fixing holes 222 of speed reducer 22. Sleeves 234, 31 and 32 are then placed into compartment 11 of housing 1, with protrusions 313, 323 of ribs 31, 32 pressing against the inner periphery of housing 1. Next, fasteners are extended through fixing holes 12, 13 and fixing holes 316, 326 of front and rear sleeves 31, 32 to securely fix front and rear sleeves 31, 32 to housing 1.

Operating rod 4 is coupled with engaging portion 2332 of coupling block 233 and moves jointly with driving device 2. Shade mechanism 5 includes a shade 51 coupled with operating rod 4 such that rotation of operating rod 4 causes lifting or lowering of shade 51.

Motor 21 can be activated to drive shaft 221 of speed reducer 22 to turn, which in turn lifts or lower shade 51 via rotation of transmission block 231, guide 232, coupling block 233 and operating rod 4. A buffering effect is provided by front and rear sleeves 31, 32 pressing against the inner periphery of housing 1, reducing high noise due to vibration generated during operation of motor 21 and speed reducer 22 and transmitted to housing 1. Furthermore, central holes 311, 321, recesses 312, 322, gaps 314, 324, and holes 315, 325 of front and rear sleeves 31, 32 enhance the deforming/buffering effect of front and rear sleeves 31, 32 and noise-reducing effect.

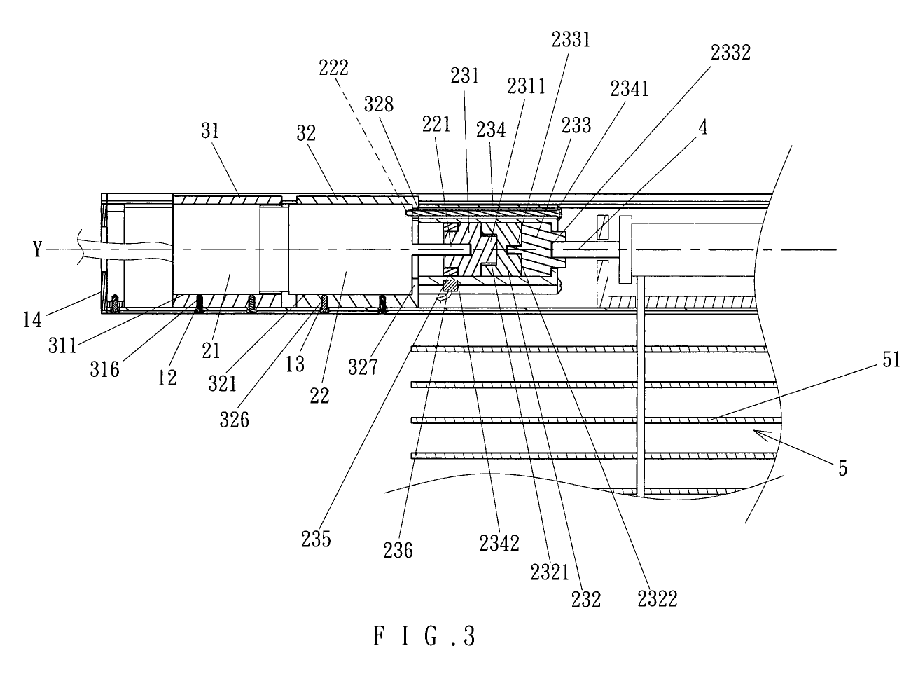

In a case that a longitudinal axis Y (FIG. 3) of operating rod 4 shifts due to a heavier load from a heavier shade 51, coupling block 233 shifts relative to guide 232, and guide 232 shifts relative to transmission block 231, compromising adverse shifting effect of operating rod 4 to speed reducer 22 and motor 21. Furthermore, front and rear sleeves 31, 32 enhance buffering effect when motor 21 and speed reducer 22 are subjected to force. The vibration noise resulting from reactive force from operating rod 4 to motor 21 and speed reducer 22 can be reduced while providing better stability during operation.

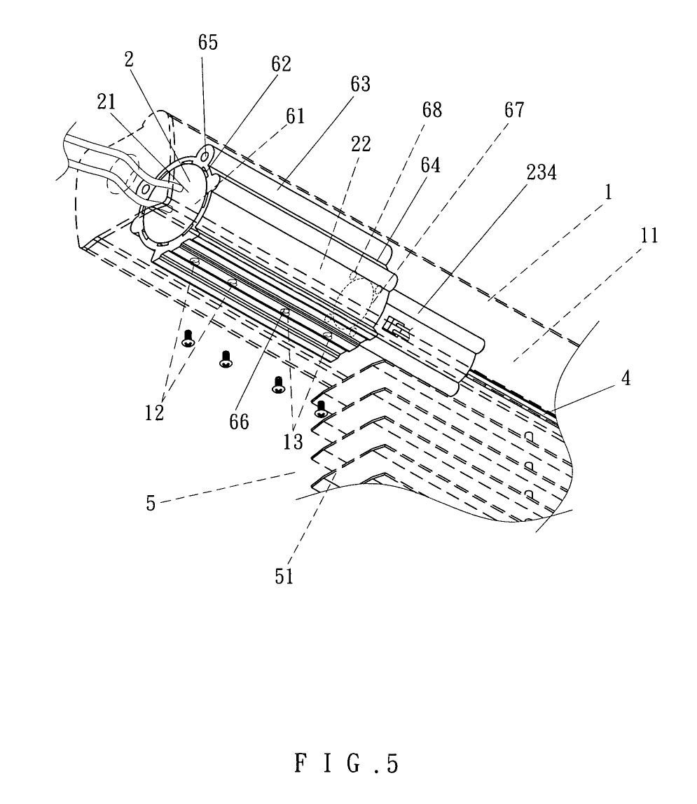

FIG. 5 shows a modified example of the motorized shade assembly according to the preferred teachings of the present invention, wherein the sleeves 31 and 32 are integrally formed as a single sleeve 6. Particularly, the sleeve 6 includes a central hole 61 receiving motor 21 and speed reducer 22. A plurality of recesses 62 are formed on an inner periphery of central hole 61 and not in contact with motor 21 and speed reducer 22. Sleeve 6 further includes a plurality of ribs 63 formed on an outer periphery thereof. Ribs 63 press against the inner periphery of housing 1 with appropriate tightness, with gaps 64 existing between the outer periphery of sleeve 6 and the inner periphery of housing 1. Some of ribs 63 include a hole 65 for enhancing the buffering effect. Sleeve 6 further includes engaging holes 66 aligned with fixing holes 12, 13. Sleeve 6 further includes an inner flange 67 in an end thereof. Annular flange 67 includes fixing holes 68 aligned with fixing holes 222 (not shown in FIG. 5) of speed reducer 22. Assembly of sleeve 6, motor 21, and speed reducer 22 is substantially the same as that of the first embodiment. Sleeve 6 performs the vibration/noise reducing function in a similar manner of sleeves 31, 32 in the first embodiment.

Operating rod 4 can be directly coupled with shaft 221 of speed reducer 22, and transmission device 3 can be omitted. The vibration/noise reducing effect is not adversely affected. Furthermore, recesses 312, 322, 62, gaps 314, 324, 64, and holes 315, 325, 65 of sleeves 31, 32, 6 can be omitted. The vibration/noise reducing effect can be obtained by buffering and flexible properties of sleeves 31, 32, 6 coupled with motor 21 and speed reducer 22 and tightly pressing between sleeves 31, 32, 6 and the inner periphery of housing 1. Shade 51 can have other forms including but not limited to a blind, a projection screen, or a continuous shade.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A motorized shade assembly comprising:
a housing including a compartment defined by an inner periphery;
a driving device mounted in the compartment and including a shaft;
an operating rod coupled with the shaft to turn therewith;
a shade coupled to the operative rod to move therewith;
a vibration absorbing member made of a buffering, flexible material, with the vibration absorbing member including a central hole having an inner periphery clamping the driving device, with the vibration absorbing member further including an outer periphery pressing against the inner periphery of the housing,
with the driving device being operable to move the operating rod and the shade, with the vibration absorbing member reducing vibration and noise generated during operation of the driving device.

2. The motorized shade assembly as claimed in claim 1, with the vibration absorbing member being a sleeve, with the driving device including a motor and a speed reducer drivable by the motor, with the speed reducer including the shaft, and with the motor and the speed reducer being received in and clamped by the sleeve.

3. The motorized shade assembly as claimed in claim 2, with the inner periphery of the sleeve including a plurality of recesses not in contact with the motor and the speed reducer.

4. The motorized shade assembly as claimed in claim 1, with the outer periphery of the vibration absorbing member including a plurality of ribs pressing against the inner periphery of the housing, with a plurality of gaps existing between the outer periphery of the vibration absorbing member and the inner periphery of the housing.

5. The motorized shade assembly as claimed in claim 4, with at least one of the plurality of ribs including a hole.

6. The motorized shade assembly as claimed in claim 2, with the motorized shade assembly further comprising, combination:
an outer sleeve mounted in the compartment of the housing;
a transmission block mounted in the outer sleeve and including a first end coupled with the shaft and a second end, with a first protrusion being formed on the second end of the transmission block;
a guide mounted in the outer sleeve and including first and second grooves formed in first and second ends thereof, with the second groove extending perpendicularly to the first groove, with the first groove being larger than and receiving the first protrusion of the transmission block such that the guide is capable of moving jointly with the transmission block and capable of shifting relative to the transmission block; and
a coupling block mounted in the outer sleeve and including a second protrusion formed on a first end thereof, with the second protrusion of the coupling block being smaller than and received in the second groove such that the coupling block is capable of moving jointly with the guide and capable of shifting relative to the guide, with the coupling block further including a second end coupled with the operative rod.

7. The motorized shade assembly as claimed in claim 6, with the speed reducer including a plurality of first fixing holes, with the sleeve including an inner flange in an end thereof, with the inner flange including a plurality of second fixing holes aligned with the plurality of second fixing holes, with the outer sleeve including a plurality of third fixing holes aligned with the first and second fixing holes, with the motorized shade assembly further comprising, in combination: a plurality of fasteners extending through the first, second, and third fixing holes.

8. The motorized shade assembly as claimed in claim 1, with the driving device including a motor and a speed reducer drivable by the motor, with the speed reducer including the shaft, with the vibration absorbing member including front and rear sleeves, with the motor being received in and clamped by the front sleeve, and with the speed reducer being received in and clamped by the rear sleeve.

9. The motorized shade assembly as claimed in claim 8, with the front sleeve including an inner periphery having a plurality of first recesses not in contact with the motor, with the front sleeve further including an outer periphery having a plurality of first ribs pressing against the inner periphery of the housing, with a plurality of first gaps existing between the outer periphery of the front sleeve and the inner periphery of the housing.

10. The motorized shade assembly as claimed in claim 9, with the rear sleeve including an inner periphery having a plurality of second recesses not in contact with the speed reducer, with the rear sleeve further including an outer periphery having a plurality of second ribs pressing against the inner periphery of the housing, with a plurality of second gaps existing between the outer periphery of the rear sleeve and the inner periphery of the housing.

11. The motorized shade assembly as claimed in claim 10, with at least one of the plurality of first and second ribs including a hole.

12. The motorized shade assembly as claimed in claim 10, with the motorized shade assembly further comprising, combination:
an outer sleeve mounted in the compartment of the housing;
a transmission block mounted in the outer sleeve and including a first end coupled with the shaft and a second end, with a first protrusion being formed on the second end of the transmission block;
a guide mounted in the outer sleeve and including first and second grooves formed in first and second ends thereof, with the second groove extending perpendicularly to the first groove, with the first groove being larger than and receiving the first protrusion of the transmission block such that the guide is capable of moving jointly with the transmission block and capable of shifting relative to the transmission block; and
a coupling block mounted in the outer sleeve and including a second protrusion formed on a first end thereof, with the second protrusion of the coupling block being smaller than and received in the second groove such that the coupling block is capable of moving jointly with the guide and capable of shifting relative to the guide, with the coupling block further including a second end coupled with the operative rod.

13. The motorized shade assembly as claimed in claim 12, with the speed reducer including a plurality of first fixing holes, with the rear sleeve including an inner flange in an end thereof, with the inner flange including a plurality of second fixing holes aligned with the plurality of second fixing holes, with the outer sleeve including a plurality of third fixing holes aligned with the first and second fixing holes, with the motorized shade assembly further comprising, in combination: a plurality of fasteners extending through the first, second, and third fixing holes.
